(19) United States
(12) Patent Application Publication
(10) Pub. No.: US 2012/0252931 A1
(43) Pub. Date: Oct. 4, 2012

(54) STABILIZER COMPOSITION FOR FILLED POLYMERS AND NANOCOMPOSITES

(75) Inventor: Rudolf Pfaendner, Rimbach (DE)

(73) Assignee: BASF SE, LUDWIGSHAFEN (DE)

(21) Appl. No.: 13/511,153

(22) PCT Filed: Nov. 30, 2010
(86) PCT No.: PCT/EP10/68462

§ 371 Date: Jun. 20, 2012

(30) Foreign Application Priority Data
Dec. 2, 2009 (EP) 09177737.5

(51) Int. Cl. C08L 63/00; C08K 5/134

(52) U.S. Cl. 523/437

(57) ABSTRACT

The present invention relates to a stabilizer composition comprising a phenolic antioxidant and/or a processing stabilizer together with selected glycidyl(meth)acrylate copolymers and a filled thermoplastic polymer, in particular a nanocomposite. Further aspects of the invention are a process for the stabilization of filled thermoplastic polymers, in particular nanocomposites with a phenolic antioxidant and/or a processing stabilizer together with selected glycidyl(meth)acrylate copolymers and the use of such a composition for the stabilization of filled thermoplastic polymers, in particular nano-composites.

### DESCRIPTION

The present invention relates to a stabilizer composition comprising a phenolic antioxidant and/or a processing stabilizer together with selected glycidyl(meth)acrylate copolymers and a filled thermoplastic polymer, in particular a nanocomposite. Further aspects of the invention are a process for the stabilization of filled thermoplastic polymers, in particular nanocomposites with a phenolic antioxidant and/or a processing stabilizer together with selected glycidyl(meth)acrylate copolymers and the use of such a composition for the stabilization of filled thermoplastic polymers, in particular nano-composites.

It is well known that polymer materials containing fillers suffer from inferior oxidative and photooxidative stability in comparison to unfilled materials. Mainly interactions between the stabilizer and the filler and absorption/desorption mechanisms are responsible for this effect. Therefore, it is challenging to achieve the desired processing and long-term properties of filled polymers. If nano-sized fillers (e.g. layered silicates) are used it is even more difficult to identify a suitable stabilization system as the surface of the filler is very large and reactive sites are present on the filler surface. Details on the state of the art stabilization of filled polymers and nanocomposites are, for example, summarized by R. Pfaendner, Stabilisation of polymer nanocomposites, in “Industry guide to polymer nanocomposites” ed. G. Beyer, p. 117-135, Plastics Information Direct, 2009.

A potential solution to cope with the stabilization challenge of filled polymers is the use of filler deactivators which block the surface of the filler, e.g. stearates, stearylamides, polyethylene glycoles, silanes, titanates, epoxides.

EP 1 592 741 discloses combinations of a thermoplastic polymer, a phyllosilicate in nanoparticles, a phenolic antioxidant and/or processing stabilizer and amongst others a polyfunctional compound based on epoxides. However, the described and exemplified epoxides are low molecular weight or oligomeric materials, polymeric acrylate-copolymers or any other copolymer containing glycidyl(meth)acrylate is not mentioned. The bisphenol-A-diglycidylether derivatives suggested in EP 1 592 741 may give rise to environmental concerns in the future, in particular when used in higher amounts, due to bisphenol-A.

The technical problem underlying the instant invention is, therefore, the provision of a highly effective stabilizer composition which is effective even at low epoxide concentrations without giving rise to environmental concerns.

This problem has been solved by incorporating a composition of polyacrylate-co-glycidyl(meth)acrylate or polystyrene-co-glycidyl(meth)acrylate copolymers and phenolic antioxidants and/or processing stabilizers to filled thermoplastic polymers. The resulting stabilized thermoplastic polymer exhibits a surprisingly high stability against the deleterious effects of heat and light, even at relative low epoxide concentrations. Furthermore, mechanical properties of filled thermoplastic polymers, in particular nano-composites are significantly improved.

One aspect of the invention is a composition comprising
a) a thermoplastic polymer,
b) a filler
c) a phenolic antioxidant and/or a processing stabilizer, and
d) a copolymer of recurring units of an epoxy-functional (meth)acrylic acid derivative, a non-functional styrene derivative and/or a non functional (meth)acrylic acid derivative.

Suitable thermoplastic polymers are:
1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).
2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
4. Hydrocarbon resins (for example C5-C₉) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic; where atactic polymers are preferred. Stereoblock polymers are also included.
5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.
6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.
7. Graft copolymers of vinyl aromatic monomers such as styrene or a-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrite/alkyl acrylate copolymers, acrylonitrile/alkoxyalkyl acrylate or acrylonitrile/vinyl halide copolymers or acrylonitrile/methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes which contain ethylene oxide as a comonomer; polyacetals modified with thermoplastic polyurethanes, acrylates or MBS.
14. Polyphenylene oxides and sulfides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and copolyamides derived from diamines and dicarboxylic acids and/or from aminocarboxylic acids or the corresponding lactams, for example polyamide 4, polyamide 6, polyamide 6/6, 4/10, 5/10, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides con- densed during processing (RIM polyamide systems).
17. Polyureas, polyimides, polyamide-imides, polyetherimids, polyesterimids, polyhydantoins and polybenzimidazoles.
18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block copolyether esters derived from hydroxyl-terminated polyethers; and also polyesters modified with polycarbonates or MBS.
19. Polycarbonates and polyester carbonates.
20. Polyketones.
21. Polysulfones, polyether sulfones and polyether ketones.
22. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

For example, the thermoplastic polymer, component a) is a polyolefin, a polystyrene, a polyamide or a polyester; preferably the thermoplastic polymer, component a) is polypropylene or polyethylene.

Typical fillers are, for example, calcium carbonate, silicates, talc, kaolin, mica, barium sulfate, metal oxides and hydroxides, carbon black, single and multiwall carbon nanotubes, graphite, graphene, wood flour and flours or fibers of other natural products, such as sisal, jute, flax or synthetic fibers such as polyamide, polyesters, aramid, polyvinyl alcohol fibers.

Preferably the filler, component b) is an inorganic filler and selected from the group consisting of calcium carbonate, talc, kaolin, wollastonite, magnesium carbonate, dolomite, calcium sulfate, barium sulfate, silica, aluminiumtrihydroxide, magnesium hydroxide, mica, clay and natural or synthetic phyllosilicates.

The fillers of choice can be of any shape or particle geometry e.g. cubic or spheroidal form, platelets or fibers.

Furthermore preferred fillers have a specific surface area of at least 3, more preferred of 5 m²/g, most preferred of 10 m²/g (determined by liquid nitrogen adsorption (B.E.T. method). Consequently preferred fillers have an average particle size of less than 5 μm, more preferred less than 2 μm and most preferred less than 1 μm.

In a specific embodiment the filler, component b), is a layered silicate clay in nanoparticles.

In particular the filler, component b) is a montmorillonite, bentonite, beidelite, mica, hectorite, saponite, nontronite, sauconite, vermiculite, ledikite, magadite, kenyaite, stevensite, volkonskoite or a mixture thereof in nanoparticles.

Component (b) may be modified or intercalated by a modification agent such as, for example, an ammonium, an amine or a phosphonium compound.

Examples of modification agents for nano-clays are for example:
1. Amine and ammonium compounds, for example, distearyldimethylammonium chloride, stearylbenzyldimethylammonium chloride, stearylamine, stearyldiethoxyamine or aminododecanoic acid [commercially available as Nanofil (RTM) from Südchemie, Germany]; dimethyl ditallow ammonium, trioctylmethyl ammonium, dipolyoxyethylenealkylmethyl ammonium or polyoxypropylenemethyldiethyl ammonium [commercially available as modified Somasif (RTM) from CO-OP Chemical]; octadecylamine, triethoxysilanyl-propylamine [commercially available as Nanomer (RTM) from Nanocor], polyalkoxylated ammonium compounds such as for example octadecyl bis(polyoxyethylene[15]amine [Ethomeen (RTM) from Eastman] or octadecyl methyl bis(polyoxyethylene[15]ammonium chloride [Etoquad (RTM) from Eastman] or just the corresponding free amines.
2. Phosphonium compounds, for example tetrabutylphosphonium or octadecyl triphenyl phosphonium [commercially available from Eastman].
3. Others, for example, triethoxy octyl silane [commercially available as Nanomer (RTM) from Nanocor], ammonium, sulfonium or pyridium compounds as disclosed for example in WO-A-01/04050 or WO-A-99/67790; block graft copolymers such as for example PEO-b-PS or poly-4-vinylpyridine-b-PS; or solvents for swelling such as for example γ-butyrolactone, 2-pyrrolidone, dimethylsulfoxide, diglyme, tetrahydrofuran or furfuryl alcohol.

For example, the filler, component b) is modified by an ammonium or phosphonium compound.

Preferably the phenolic antioxidant, component c) is a compound of the formula I

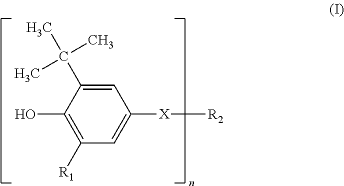

in which

R₁ is C₁-C₄alkyl,

n is 1, 2, 3 or 4,

X is methylene,

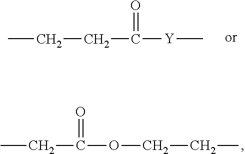

Y is hydrogen or —NH—; and,

if n is 1,

X is

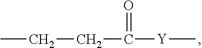

where Y is attached to R₂, and

R₂ is C₁-C₂₅alkyl; and,

if n is 2,

X is

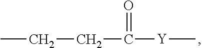

where Y is attached to R₂, and

R₂ is C₂-C₁₂alkylene, C₄-C₁₂alkylene interrupted by oxygen or sulfur; or, if Y is —NH—, R₂ is additionally a direct bond; and,

if n is 3,

X is methylene or

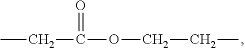

where the ethylene group is attached to R₂, and

R₂ is

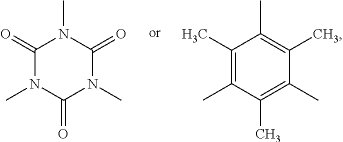

and,

if n is 4,

X is

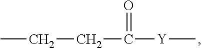

where Y is attached to R₂, and

R₂ is C₄-C₁₀alkanetetrayl.

Alkyl having up to 25 carbon atoms is a branched or unbranched radical, for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, eicosyl or docosyl. A preferred definition of R₁ is methyl and tert-butyl. A particularly preferred definition of R₂ is C₁-C₂₀alkyl, especially C₁-C₁₈alkyl, for example C₄-C₁₈alkyl. An especially preferred definition of R₂ is C₈-C₁₈alkyl, especially C₁₄-C₁₈alkyl, for example C₁₈alkyl.

C₂-C₁₂alkylene is a branched or unbranched radical, for example ethylene, propylene, tetramethylene, pentamethylene, hexamethylene, heptamethylene, octamethylene, decamethylene or dodecamethylene. A preferred definition of R₂ is, for example, C₂-C₁₀alkylene, especially C₂-C₈alkylene. An especially preferred definition of R₂ is, for example, C₄-C₆alkylene, especially C₄-C₆alkylene, for example hexamethylene.

C₄-C₁₂alkylene interrupted by oxygen or sulfur can be interrupted one or more times and is, for example, —CH₂—O—CH₂CH₂—O—CH₂—, —CH₂—(O—CH₂CH₂—)₂O—CH₂—, —CH₂₋(O—CH₂CH₂₋)₃O—CH₂—, —CH₂—(O—CH₂CH₂—)₄O—CH₂—, —CH₂CH₂—O—CH₂CH₂—O—CH₂CH₂— or —CH₂CH₂—S—CH₂CH₂—. A preferred definition of R₂ is, for example, C₄-C₁₀alkylene interrupted by oxygen or sulfur, especially C₄-C₈alkylene interrupted by oxygen or sulfur, for example C₄-C₆alkylene interrupted by oxygen or sulfur. An especially preferred meaning of R₂ is —CH₂CH₂—O—CH₂CH₂—O—CH₂CH₂— or —CH₂CH₂—S—CH₂CH₂—.

Alkanetetrayl having 4 to 10 carbon atoms is, for example,

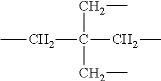

(pentaerythrityl),

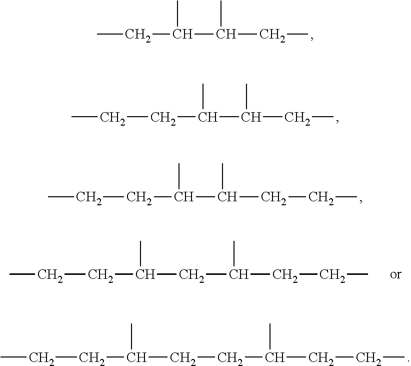

Pentaerythrityl is preferred.

Component (c) may also comprise mixtures of different sterically hindered phenols of the formula I.

The compositions of interest include those comprising as component (c) at least one compound of the formula I in which, if n is 1, R₂ is C₁-C₂₀alkyl.

Preference is given to compositions comprising as component (c) at least one compound of the formula I in which,

if n is 2,

R₂ is C₂-C₈alkylene, C₄-C₈alkylene interrupted by oxygen or sulfur; or, if Y is —NH—, R₂ is additionally a direct bond; and,

if n is 3,

X is methylene,

R₂ is

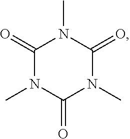

and,

if n is 4,

R₂ is C₄-C₈alkanetetrayl.

Preference is likewise given to compositions comprising as component (c) at least one compound of the formula I in which

R₁ is methyl or tert-butyl,

n is 1, 2, 3 or 4,

X is methylene or

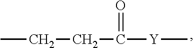

Y is hydrogen or —NH—; and,

if n is 1,

R₂ is C₁₄-C₁₈alkyl; and

if n is 2,

R₂ is C₄-C₆alkylene, or is C₄-C₆alkylene interrupted by oxygen; and,

if n is 3,

X is methylene,

R₂ is

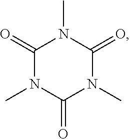

and,

if n is 4,

R₂ is C₄-C₆alkanetetrayl.

Likewise of interest are compositions comprising as component (c) at least one compound of the formula I in which the compound of the formula I is a compound of the formula Ia to Ii

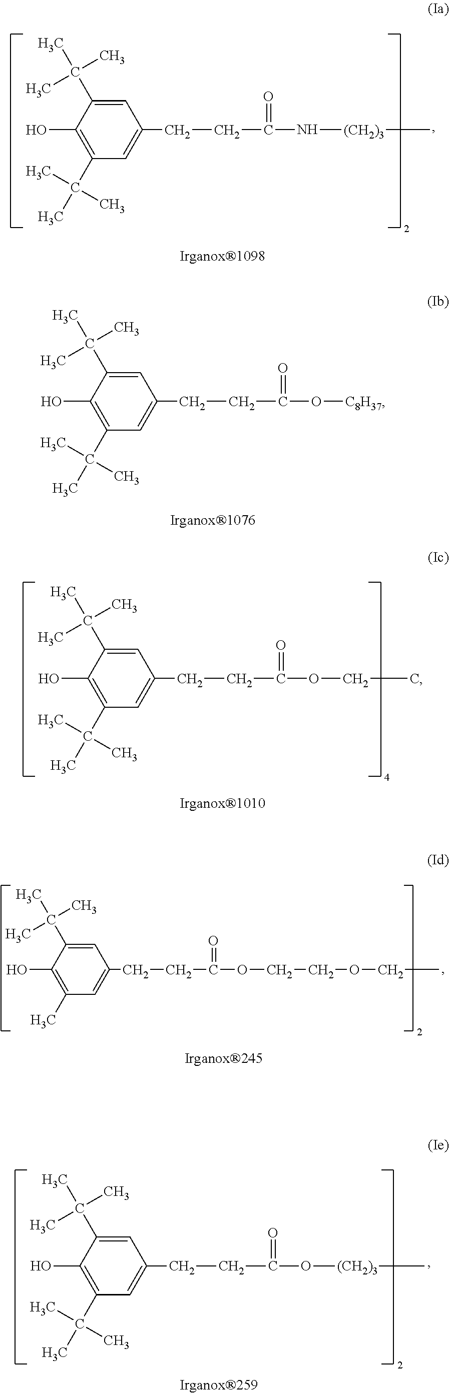

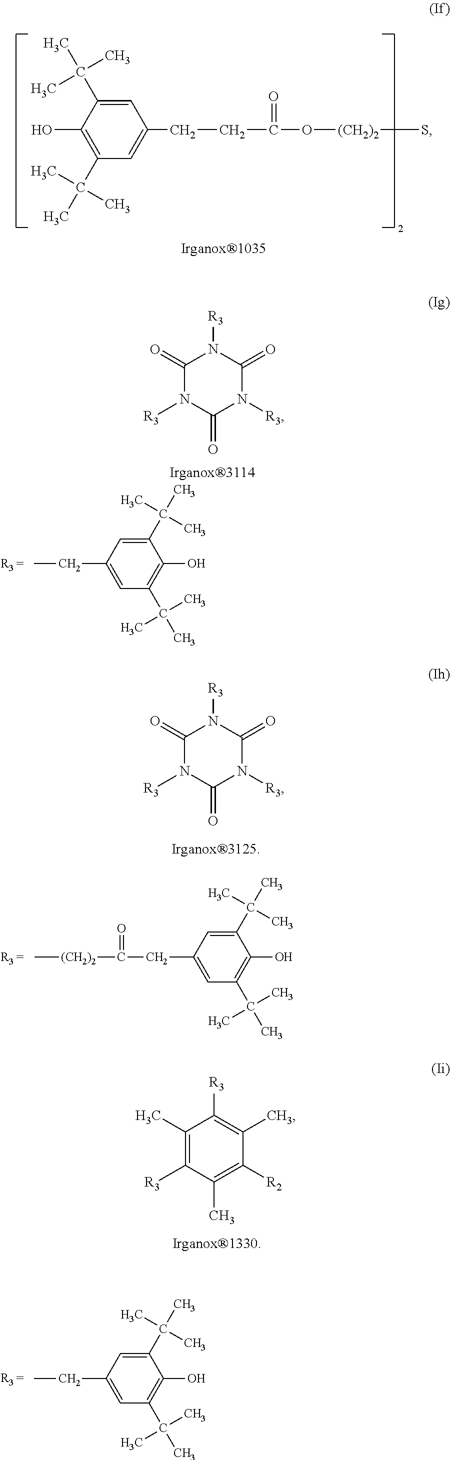

Irganox®1098, Irganox®1076, Irganox®1010, Irganox®245, Irganox®259, Irganox®3114, Irganox®1035, Irganox®3125 and Irganox®1330 are protected trade names of Ciba Inc.

Preference is given to nanocomposite materials comprising as component (c) at least one compound of the formula I in which the compound of the formula I is a compound of the formula Ia, Ib, Ic or Id, in particular a compound of the formula Ia, Ib or Ic.

Component (c) of the novel nanocomposite materials, and the compounds of the formula I, are known and in some cases obtainable commercially. Possible preparation processes for the compounds of the formula I can be found, for example, in the U.S. Pat. Nos. 3,330,859 or 3,960,928.

Of interest are also compositions, comprising as component (c) processing stabilizers selected from the group consisting of organic phosphites or phosphonites.

Of particular interest are compositions comprising as component (c) at least one compound of the group of the organic phosphites or phosphonites of the formulae II to VIII

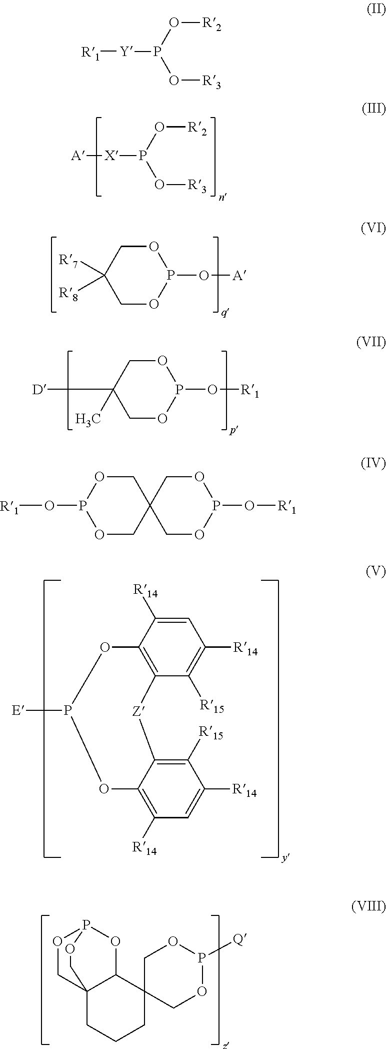

in which the indices are integral and n′ is 2, 3 or 4; p′ is 1 or 2; q′ is 2 or 3; r′ is 4 to 12; y′ is 1, 2 or 3; and z′ is 1 to 6;

A′, if n′ is 2, is C₂-C₁₈alkylene; C₂-C₁₂alkylene interrupted by oxygen, sulfur or —NR′₄—; a radical of the formula

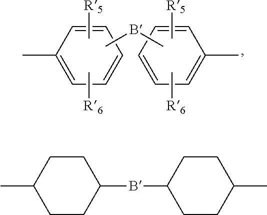

or phenylene;

A′, if n′ is 3, is a radical of the formula —C_{r′}H_{2r′-1}—;

A′, if n′ is 4, is

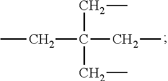

A″ has the meaning of A′ if n′ is 2;

B′ is a direct bond, —CH₂—, —CHR′₄—, —CR′₁R′₄—, sulfur or C₅-C₇cycloalkylidene, or is cyclohexylidene substituted by from 1 to 4 C₁-C₄alkyl radicals in position 3, 4 and/or 5;

D′, if p′ is 1, is methyl and, if p′ is 2, is —CH₂OCH₂—;

E′, if y′ is 1, is C₁-C₁₈alkyl, —OR′₁ or halogen;

E′, if y is 2, is —O—A″—O—,

E′, if y is 3, is a radical of the formula R′₄C(CH₂O—)₃ or N(CH₂CH₂O—)₃;

Q′ is the radical of an at least z′-valent alcohol or phenol, this radical being attached via the oxygen atom to the phosphorus atom;

R′₁, R′₂ and R′₃ independently of one another are unsubstituted or halogen, —COOR₄′, —CN— or —CONR₄′R₄′-substituted C₁-C₁₈alkyl; C₂-C₁₈alkyl interrupted by oxygen, sulfur or —NR′₄—; C₇-C₉phenylalkyl; C₅-C₁₂cycloalkyl, phenyl or naphthyl; naphthyl or phenyl substituted by halogen, 1 to 3 alkyl radicals or alkoxy radicals having in total 1 to 18 carbon atoms or by C₇-C₉phenylalkyl; or are a radical of the formula

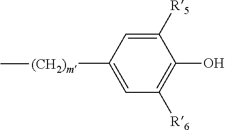

in which m′ is an integer from the range 3 to 6;

R′₄ is hydrogen, C₁-C₁₈alkyl, C₅-C₁₂cycloalkyl or C₇-C₉phenylalkyl,

R′₅ and R′₆ independently of one another are hydrogen, C₁-C₈alkyl or C₅-C₆cycloalkyl,

R′₇ and R′₈, if q′ is 2, independently of one another are C₁-C₄alkyl or together are a 2,3-dehydropentamethylene radical; and

R′₇ and R′₈, if q′ is 3, are methyl;

R′₁₄ is hydrogen, C₁-C₉alkyl or cyclohexyl,

R′₁₅ is hydrogen or methyl and, if two or more radicals R′₁₄ and R′₁₅ are present, these radicals are identical or different,

X′ and Y′ are each a direct bond or oxygen,

Z′ is a direct bond, methylene, —C(R′₁₆)₂— or sulfur, and

R′₁₆ is C₁-C₈alkyl.

Preferably the processing stabilizer, component c) is a compound of the formula II, III, IV or V

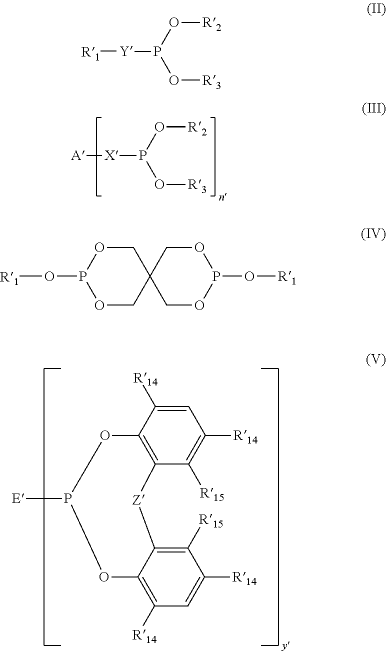

in which

n′ is the number 2 and y′ is the number 1, 2 or 3;

A′ is C₂-C₁₈alkylene, p-phenylene or p-biphenylene,

E′, if y′ is 1, is C₁-C₁₈alkyl, —OR′₁ or fluorine;

E′, if y′ is 2, is p-biphenylene,

E′, if y′ is 3, is N(CH₂CH₂O—)₃,

R′₁, R′₂ and R′₃ independently of one another are C₁-C₁₈alkyl, C₇-C₉phenylalkyl, cyclohexyl, phenyl, or phenyl substituted by 1 to 3 alkyl radicals having in total 1 to 18 carbon atoms;

R′₁₄ is hydrogen or C₁-C₉alkyl,

R′₁₅ is hydrogen or methyl;

X′ is a direct bond,

Y′ is oxygen,

Z′ is a direct bond or —CH(R′₁₆)—, and

R′₁₆ is C₁-C₄alkyl.

Particular preference is given to nanocomposite materials comprising as component (c) a phosphite or phosphonite of the formula II, III or V.

Special preference is given to nanocomposite materials comprising as component (c) at least one compound of the formula VII

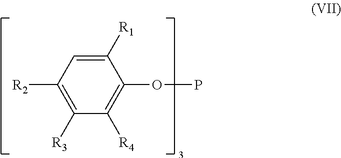

in which

R₁ and R₂ independently of one another are hydrogen, C₁-C₈alkyl, cyclohexyl or phenyl, and

R₃ and R₄ independently of one another are hydrogen or C₁-C₄alkyl.

The following compounds are examples of organic phosphites and phosphonites which are particularly suitable as component (c) in the compositions.

Triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite (Irgafos® 168, Ciba Specialty Chemicals Inc.), diisodecyl pentaerythritol diphosphite, bis(2,4-di-tert-butylphenyl) pentaerythritol diphosphite (formula D), bis(2,6-di-tert-butyl-4-methylphenyl) pentaerythritol diphosphite (formula E), bisisodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, tristearyl sorbitol triphosphite, tetrakis(2,4-di-tert-butylphenyl) 4,4′-biphenylenediphosphonite (Irgafos®P-EPQ, Ciba Specialty Chemicals Inc., formula H), 6-isooctyloxy-2,4,8,10-tetra-tert-butyl-12H-dibenzo[d,g]-1,3,2-dioxaphosphocin (formula C), 6-fluoro-2,4,8,10-tetra-tert-butyl-12-methyldibenzo[d,g]-1,3,2-dioxaphosphocin (formula A), bis(2,4-di-tert-butyl-6-methylphenyl) methyl phosphite, bis(2,4-di-tert-butyl-6-methylphenyl) ethyl phosphite (formula G).

Particular preference is given to the use of the following phosphites and phosphonites:

tris(2,4-di-tert-butylphenyl) phosphite (Irgafos®168, Ciba Specialty Chemicals Inc.), tris(nonylphenyl) phosphite,

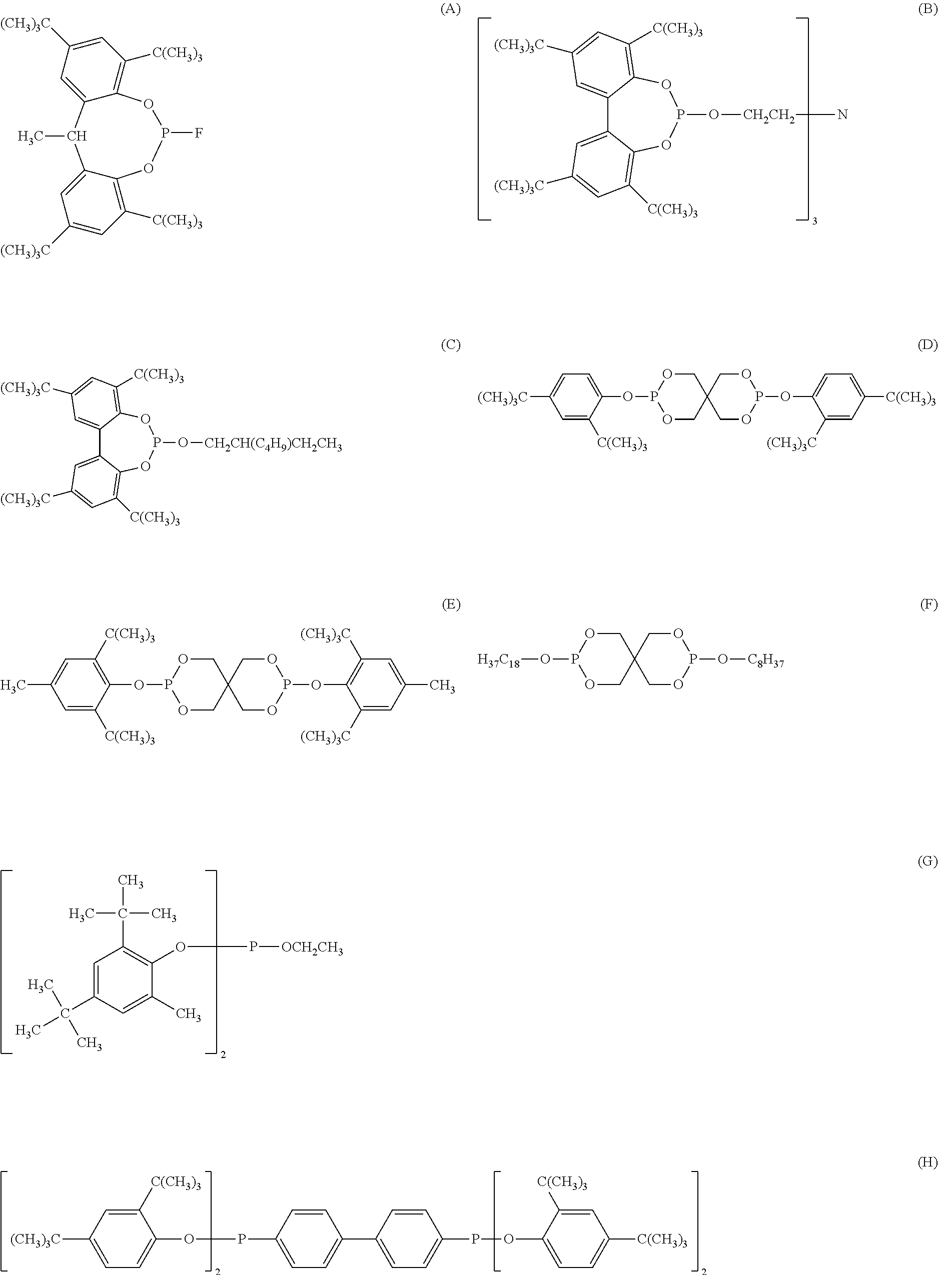

Very particular preference is given to tris(2,4-di-tert-butylphenyl) phosphite [Irgafos®168, Ciba Inc.], bis(2,4-di-tert-butyl-6-methylphenyl) ethyl phosphite [Irgafos® 38, Ciba Inc., formula (G)], bis(2,4-di-tert-butylphenyl) pentaerythritol diphosphite [Irgafos®126, Ciba Inc., formula (D)] or tetrakis(2,4-di-tert-butylphenyl)-4,4′-bi-phenylenediphosphonite [Irgafos®P-EPQ, Ciba Inc., formula (H)].

The above mentioned organic phosphites and phosphonites are known compounds; many of them are available commercially.

Of very special interest are compositions wherein component (c) is tris(2,4-di-tert-butylphenyl) phosphite, bis(2,4-di-tert-butyl-6-methylphenyl) ethyl phosphite, bis(2,4-di-tert-butylphenyl) pentaerythritol diphosphite, tetrakis(2,4-di-tert-butylphenyl) 4,4′-biphenylenediphosphonite, and/or a compound of the formula Ia, Ib, Ic, Id or Ig

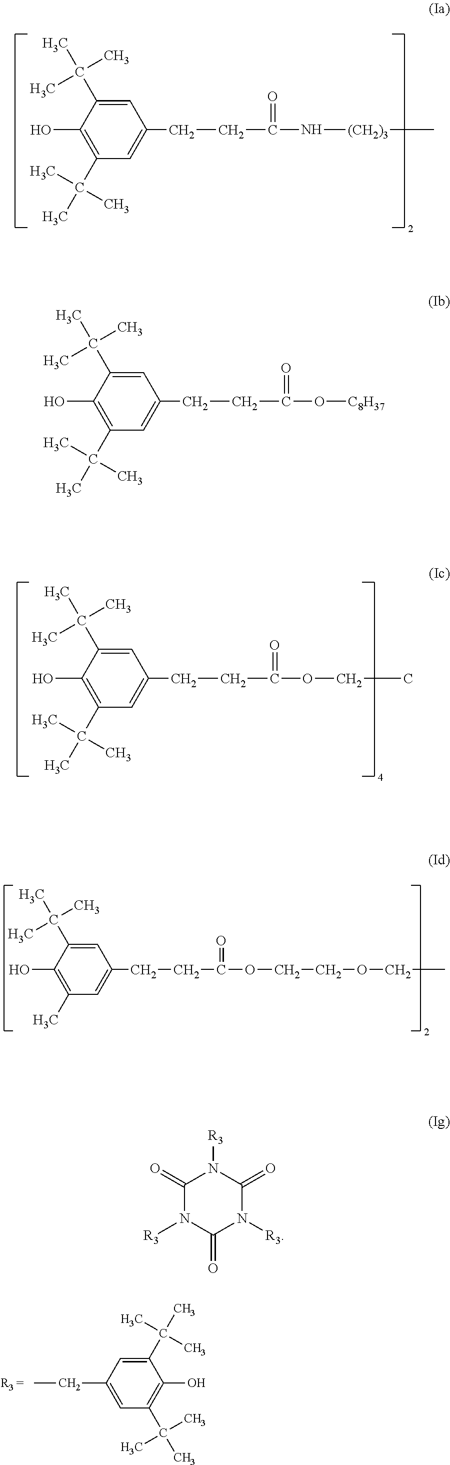

Component d) is a copolymer of recurring units of an epoxy-functional (meth)acrylic acid derivative, a non functional styrene derivative and/or a non functional (meth)acrylic acid derivative. The term (meth)acrylic acid derivative includes the free acid, esters and salts of acrylic acid and methacrylic acid. Typical esters are the methyl, ethyl, propyl, butyl, pentyl or hexyl esters. Typical salts are the sodium, potassium or zinc salts of the respective acid.

The term epoxy-functional (meth)acrylic acid derivative embraces any epoxidized derivative of acrylic and methacrylic acid. Typically these are epoxidized esters of the respective acid, such as glycidyl acrylate and glycidyl methacrylate.

A non functional styrene derivative is, for example, styrene, methylstyrene or dodecylstyrene.

Preferably the copolymer, component (d) is a copolymer of glycidyl(meth)acrylate, styrene, butylacrylate and methylmethacrylate with more than 5% by weight of glycidyl(meth)acrylate, based on the weight of the monomer mixture.

The above mentioned copolymers are items of commerce and, for example available from BASF SE under the tradename “Joncryl”(RTM), in particular Joncryl 4300, 4370, 4368, 4380 and 4385.

The amount of glycidyl(meth)acrylate is, for example from 5 to 50%, for instance from 10 to 30%, based on the weight of the monomer mixture.

Preferably, the filler, component b) is present in the composition in an amount of from 0.1 to 60%, in particular 0.1 to 20%, for example from 1 to 10%, based on the weight of the synthetic polymer, component a).

Preferably the phenolic antioxidant and/or processing stabilizer, component c) is present in the composition in an amount of from 0.01 to 5%, in particular 0.05 to 5%, for example from 0.02 to 2%, based on the weight of the synthetic polymer, component a).

When a phenolic antioxidant and a processing stabilizer are both present in the composition the above given amounts indicate the sum of both. Typically the weight ratio between phenolic antioxidant and processing stabilizer is from 1:10 to 10:1, preferably from 1:5 to 5:1.

Preferably the copolymer, component d) is present in the composition in an amount of from 0.01 to 5%, in particular 0.05 to 5%, for example from 0.1 to 5%, based on the weight of the synthetic polymer, component a).

The weight ratio between component c) and component d) is typically from 1:10 to 10:1, preferably from 1:5 to 5:1.

For example, the composition may comprise in addition, besides components (a), (b), (c) and (d), further additives selected from the group consisting of modification agents for nanocomposites, compatibilizers, light-stabilizers, dispersing or solvating agents, pigments, dyes, plasticizers and/or toughening agents. Examples for such further additives are given in EP 1 592 741.

The further additives are added, for example, in concentrations of 0.01 to 10%, relative to the total weight of the synthetic polymer to be stabilized.

Incorporation of components (b), (c) and (d) and, if desired, further additives into the synthetic polymers is carried out by known methods, for example before or during moulding or else by applying the dissolved or dispersed compounds to the synthetic polymer, if appropriate with subsequent slow evaporation of the solvent. Components (b), (c) and (d) can also be added to the synthetic polymers to be stabilized in the form of a masterbatch or concentrate containing them, for example, in a concentration of 2.5 to 25% by weight. Furthermore, it can be advantageous that the copolymer d is added as such, dissolved or dispersed to the filler b previous to any mixing or compounding step with the other ingredients. In this case a filler coated with the copolymer d is obtained. In a specific embodiment such coated filler is used as component b+d.

Consequently a further aspect of the invention is a composition as described above in the form of a masterbatch comprising

component (b) in an amount of from 0.03 to 90%, based on the weight of component (a),

component (c) in an amount of from 0.03 to 15%, based on the weight of component (a), and

component (d) in amount of from 0.03 to 15%, based on the weight of component (a).

Another aspect of the invention is a process for stabilizing a thermoplastic polymer against oxidative, thermal or light-induced degradation, which comprises incorporating in or applying to said material at least one each of components (b), (c) and (d) as described above.

Also an aspect of the invention is the use of a mixture of components (b), (c) and (d) as described above as stabilizer mixture for thermoplastic polymers against oxidative, thermal or light-induced degradation.

The definitions and preferences given above apply equally to all aspects of the invention.

The following examples illustrate the invention.

### EXAMPLES

Polypropylene powder (Profax PH 350, Basell Polyolefins, Germany) is mixed homogeneously in a high speed mixer with 5% Nanofil 15 (distearyldimethylammonium chloride modified nanodispersed layered silicate clay, supplier: Rockwood Clay Additives, Germany), 15% Polybond 3200 (maleic anhydride grafted polypropylene, supplier: Chemtura, UK) and with the additives listed in table 1. This blend is extruded in a twin screw extruder Coperion ZSK 25 at a temperature of at most 200° C. After under water strand granulation and drying, the obtained granules are injection molded at 235° C. (Arburg 320 S) into test specimens to evaluate the tensile impact strength according to ISO 8256 (TIS) and the oxygen induction time (OIT) according to ASTM D 3895-80 at 190° C.

### Additives:

Irganox B 225(RTM) is a 1:1 blend of Irganox 1010(RTM) and Irgafos 168(RTM), obtainable from Ciba Inc.

Joncryl ADR 4368(RTM) is a styrene-acrylate copolymer containing glycidylmethacrylate, obtainable from BASF SE.

TABLE 1

| | | Joncryl ADR | | TIS |
|---|---|---|---|---|
| No. | I. B 225 [%] | 4368 [%] | OIT [s] | [kJ/m²] |
| Comparison 1 | 0.2 | — | 13.3 | 128 |
| Comparison 2 | 0.5 | — | 30.3 | |
| Inventive 1 | 0.2 | 0.3 | 19.9 | |
| Inventive 2 | 0.2 | 1.0 | 21.8 | |
| Inventive 3 | 0.5 | 0.3 | 61.5 | 128 |
| Inventive 4 | 0.5 | 1.0 | 82.4 | 132 |
| Inventive 5 | 0.5 | 2.0 | 96.6 | 178 |

The inventive compositions show improved thermal stability (higher OIT values) and improved mechanical properties.

1. A composition comprising
a) a thermoplastic polymer,
b) a filler,
c) a phenolic antioxidant and/or a processing stabilizer and
d) a copolymer of recurring units of an epoxy-functional (meth)acrylic acid derivative, a non-functional styrene derivative and/or a non-functional (meth)acrylic acid derivative.

2. A composition according to claim 1 wherein the thermoplastic polymer is a polyolefin, a polystyrene, a polyamide or a polyester.

3. A composition according to claim 2 wherein the thermoplastic polymer is polypropylene or polyethylene.

4. A composition according to claim 1 wherein the filler is an inorganic filler selected from the group consisting of calcium carbonate, talc, kaolin, wollastonite, magnesium carbonate, dolomite, calcium sulfate, barium sulfate, silica, aluminiumtrihydroxide, magnesium hydroxide, mica, clay and natural or synthetic phyllosilicates.

5. A composition according to claim 1, where the filler surface area is at least 3 m²/g, as determined by liquid nitrogen adsorption (B.E.T. method).

6. A composition according to claim 1, wherein the filler is a montmorillonite, bentonite, beidelite, mica, hectorite, saponite, nontronite, sauconite, vermiculite, ledikite, magadite, kenyaite, stevensite, volkonskoite or a mixture thereof in nanoparticles.

7. A composition according to claim 5, wherein the filler is modified by an ammonium or a phosphonium compound.

8. A composition according to claim 1, comprising a phenolic antioxidant of formula I 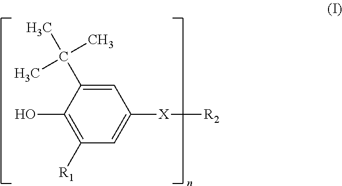
in which
R₁ is C₁-C₄alkyl,
n is 1, 2, 3 or 4,
X is methylene, 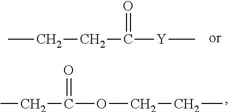
Y is oxygen or —NH—;
if n is 1,
X is 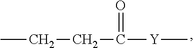
where Y is attached to R₂ and
R₂ is C₁-C₂₅alkyl; and,
if n is 2,
X is 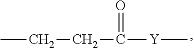
where Y is attached to R₂ and
R₂ is C₂-C₁₂alkylene, C₄-C₁₂alkylene interrupted by oxygen or sulfur; or, if Y is —NH—, R₂ is additionally a direct bond;
if n is 3,
X is methylene or 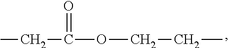
where the ethylene group is attached to R₂ and
R₂ is 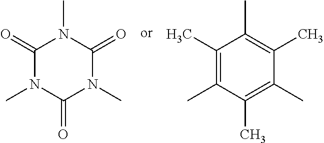
and
if n is 4,
X is 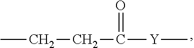
where Y is attached to R₂ and
R₂ is C₄-C₁₀alkanetetrayl.

9. A composition according to claim 1, comprising a processing stabilizer of formula II, III, IV or V 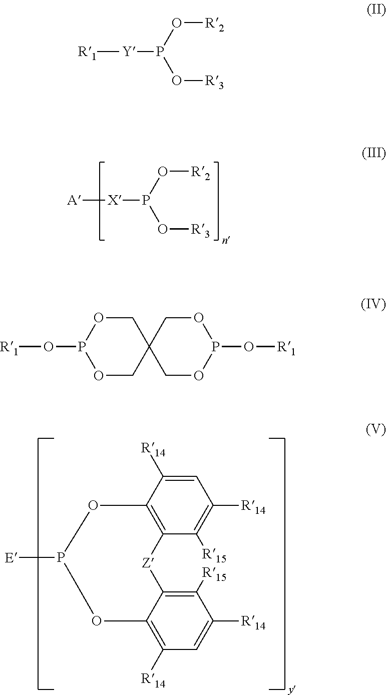
in which
n′ is the number 2 and y′ is the number 1, 2 or 3,
A′ is C₂-C₁₈alkylene, p-phenylene or p-biphenylene,
E′, if y′ is 1, is C₁-C₁₈alkyl, —OR′₁ or fluorine,
E′, if y′ is 2, is p-biphenylene,
E′, if y′ is 3, is N(CH₂CH₂O—)₃,
R′₁, R′₂ and R′₃ independently of one another are C₁-C₁₈alkyl, C₇-C₉phenylalkyl, cyclohexyl, phenyl, or phenyl substituted by 1 to 3 alkyl radicals having in total 1 to 18 carbon atoms,
R′₁₄ is hydrogen or C₁-C₉alkyl,
R′₁₅ is hydrogen or methyl,
X′ is a direct bond,
Y′ is oxygen,
Z′ is a direct bond or —CH(R′₁₆)— and
R′₁₆ is C₁-C₄alkyl.

10. A composition according to claim 1, wherein component c) is tris(2,4-di-tert-butylphenyl) phosphite, bis(2,4-di-tert-butyl-6-methylphenyl) ethyl phosphite, bis(2,4-di-tert-butylphenyl) pentaerythritol diphosphite, tetrakis(2,4-di-tert-butylphenyl) 4,4′-biphenylenedi-phosphonite, and/or a compound of formula Ia, Ib, Ic, Id or Ig

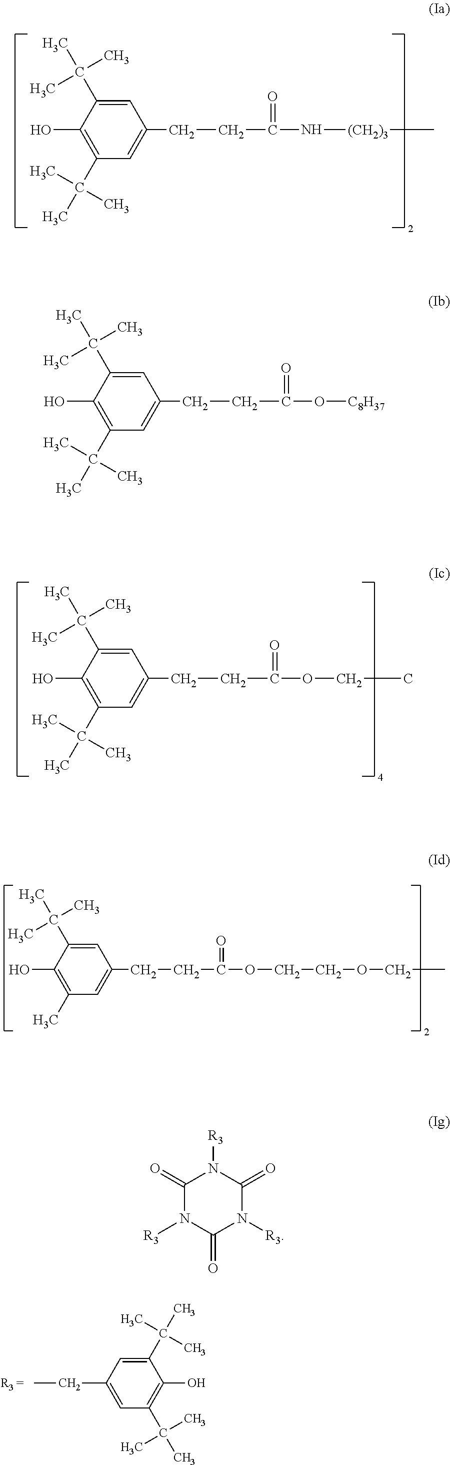

11. A composition according to claim 1 wherein the copolymer is a copolymer of glycidyl(meth)acrylate, styrene, butylacrylate and methylmethacrylate with more than 5% by weight of glycidyl(meth)acrylate, based on the weight of the monomer mixture.

12. A composition according to claim 1, further comprising additives selected from the group consisting of modification agents for nanocomposites, compatibilizers, light-stabilizers, dispersing or solvating agents, pigments, dyes, plasticizers and toughening agents.

13. A composition according to claim 1 in the form of a masterbatch comprising
component (b) in an amount of from 0.03 to 90%, based on the weight of component (a),
component (c) in an amount of from 0.03 to 15%, based on the weight of component (a) and
component (d) in amount of from 0.03 to 15%, based on the weight of component (a).

14. A process for stabilizing a thermoplastic polymer against oxidative, thermal or light-induced degradation, which process comprises incorporating in or applying to said thermoplastic polymer
b) a filler,
c) a phenolic antioxidant and/or a processing stabilizer and
d) a copolymer of recurring units of an epoxy-functional (meth)acrylic acid derivative, a non-functional styrene derivative and/or a non-functional (meth)acrylic acid derivative.

15. (canceled)
